(19) United States
(12) Patent Application Publication
(10) Pub. No.: US 2015/0332882 A1
(43) Pub. Date: Nov. 19, 2015

(54) High Temperature Float Switch System

(71) Applicant: S.J. Electro Systems, Inc., Detroit Lakes, MN (US)

(72) Inventor: Alan J. Bergum, Detroit Lakes, MN (US)

(73) Assignee: S.J. Electro Systems, Inc., Detroit Lakes, MN (US)

(21) Appl. No.: 14/277,521

(22) Filed: May 14, 2014

(51) Int. Cl. H01H 35/18

(52) U.S. Cl. CPC H01H 35/18

(57) ABSTRACT

A high temperature float switch system for usage in high temperature environments. The high temperature float switch system generally includes a housing having a double wall design that houses a switch unit within the inner wall. The double wall design is comprised of an inner wall positioned within an outer housing. An intermediate space is preferably between at least a portion of the inner wall and the outer housing to receive any water vapor that passes through the outer housing thereby preventing the entry of the water vapor into the interior space of the inner wall.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a float switch and more specifically it relates to a high temperature float switch system for usage in high temperature environments.

2. Description of the Related Art

Any discussion of the related art throughout the specification should in no way be considered as an admission that such related art is widely known or forms part of common general knowledge in the field.

Float switches are used to determining the liquid level in a tank or other water retention structure. The float switch is electrically connected to a pump (e.g. sump pump, condensate pumps), an indicator, an alarm, control panel or other device. Conventional float switches are comprised of a single wall housing defining a sealed cavity that both protects the switch within the sealed cavity and provides buoyancy to float in the liquid (e.g. water, waste water). The switch within the housing is typically comprised of a two-stage switch that has a ball positioned within a channel, a lever extending into the channel and an electrical switch connected to the lever, wherein when the ball is at a first end of the channel (e.g. outer end) the lever manipulates the electrical switch to an open state and when the ball is at a second end of the channel (e.g. inner end) the lever is allowed to extend into the channel thereby allowing the electrical switch to enter a closed state (or vice versa).

Housings for conventional float switches are typically constructed of a single wall plastic (e.g. thermoplastics, thermoplastic polymers, polypropylene, polycarbonate, polycarbonate-ABS alloy where ABS is an acronym for acrylonitrile butadiene styrene) which is suitable for normal temperature environments. However, when a float switch is required for a high temperature environment (e.g. where the liquid is heated to temperatures up to approximately 212 degrees Fahrenheit), plastic is not a suitable material for the housing because plastic is permeable to water vapor which enters the sealed cavity. One example of a high temperature environment for float switch is a sump pit that receives boiler blowdown which is water intentionally wasted from a steam boiler to avoid the concentration of impurities during continuing evaporation of steam. After the water vapor enters the sealed interior cavity, the water vapor condenses thereby corroding the electrical contacts and substrates within the float switch. The entry of water vapor into the sealed interior cavity of the float switch significantly reduces the useful life of the float switch.

To overcome the limitations of plastic housings for float switches in high temperature environments, stainless steel is sometimes used to construct the housing which does not allow for the entry of water vapor. The main problem with stainless steel housings for float switches is they are expensive to manufacture thereby significantly increasing the price of the float switch.

Because of the inherent problems with the related art, there is a need for a new and improved high temperature float switch system for usage in high temperature environments.

### BRIEF SUMMARY OF THE INVENTION

The invention generally relates to a float switch which includes a housing having a double wall design that houses a switch unit within the inner wall. The double wall design is comprised of an inner wall positioned within an outer housing. An intermediate space is preferably between at least a portion of the inner wall and the outer housing to receive any water vapor that passes through the outer housing thereby preventing the entry of the water vapor into the interior space of the inner wall.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an exploded upper perspective view of the present invention.

FIG. 3 is a side view of the present invention.

FIG. 4 is an inner end view of the present invention.

FIG. 5 is an outer end view of the present invention.

FIG. 6 is a cross sectional view taken along line 6-6 of FIG. 4.

FIG. 7 is a cross sectional view taken along line 7-7 of FIG. 3.

FIG. 8 is a top interior view of the second portion of the outer housing.

FIG. 9 is an upper perspective view of the second portion of the outer housing.

FIG. 10 is a cross sectional view taken along line 10-10 of FIG. 9.

FIG. 11 is a cross sectional view taken along line 11-11 of FIG. 9.

### DETAILED DESCRIPTION OF THE INVENTION

### A. Overview.

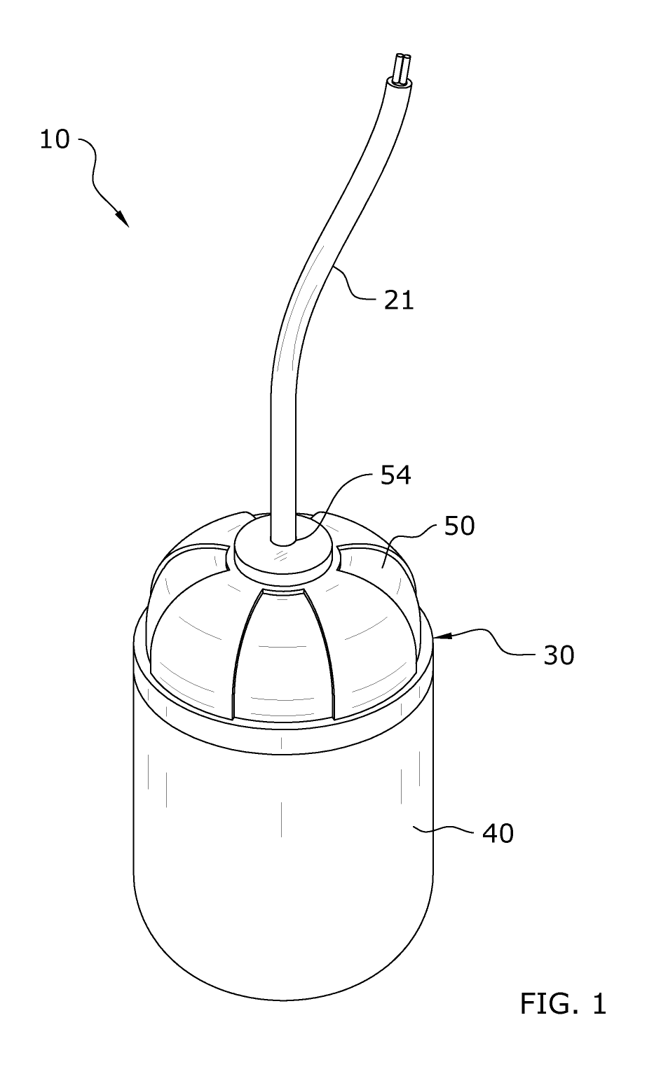

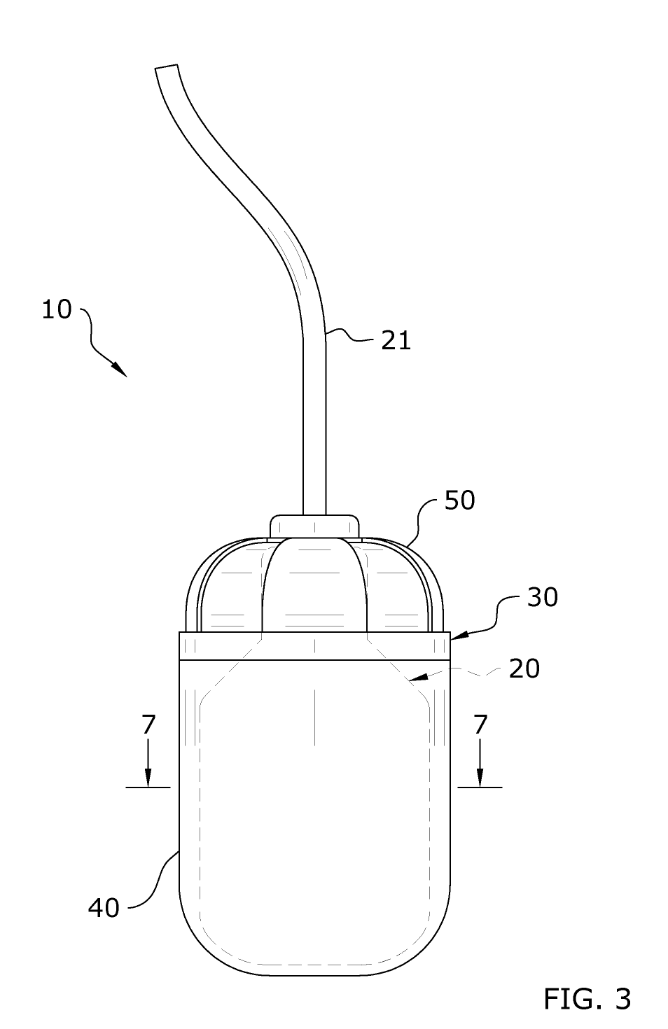

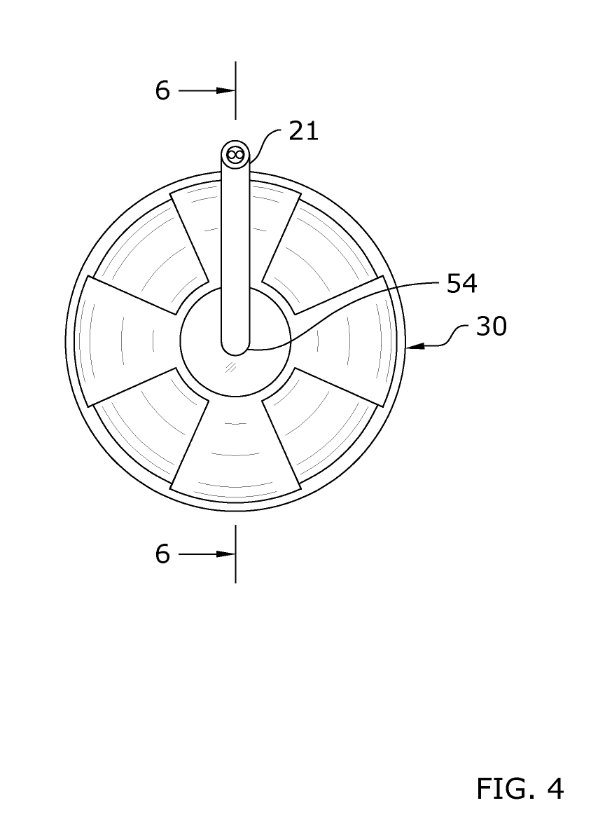

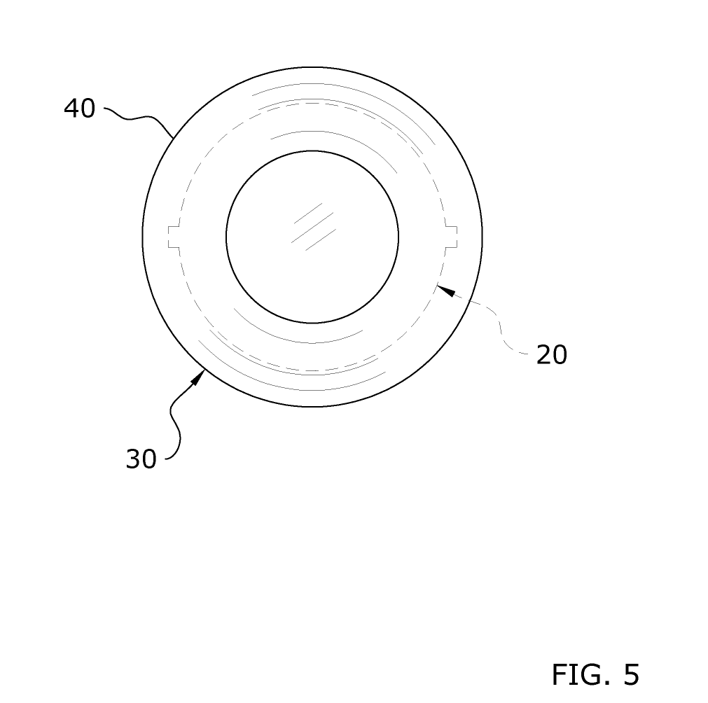

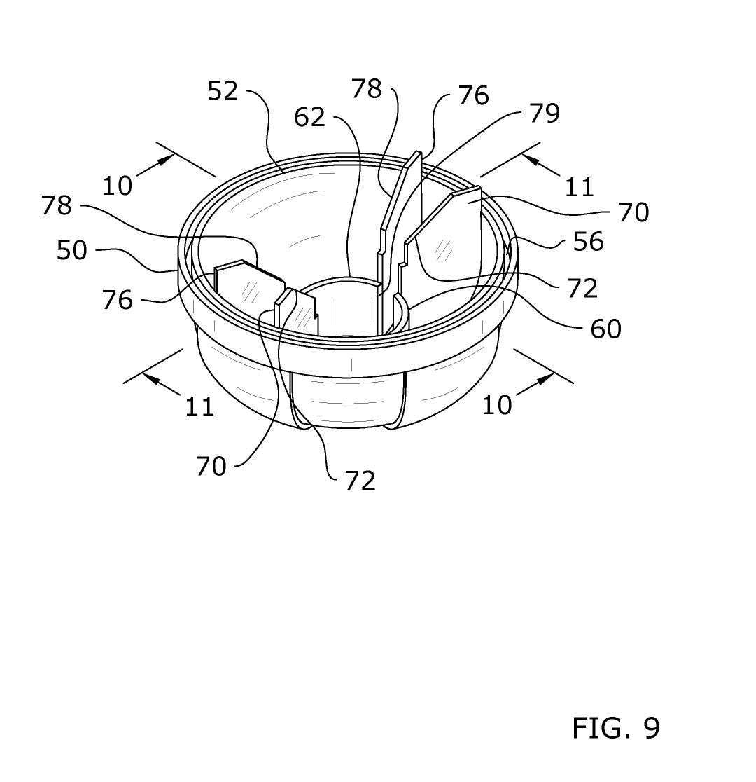

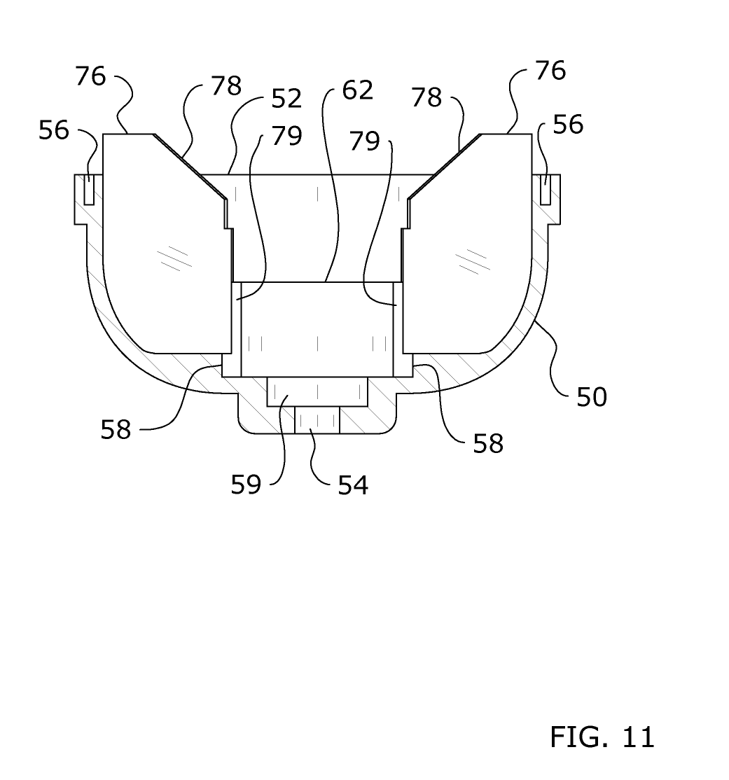

Turning now descriptively to the drawings, in which similar reference characters denote similar elements throughout the several views, FIGS. 1 through 11 illustrate a high temperature float switch system 10, which comprises a housing having a double wall design that houses a switch unit 28 within the inner wall 22. The double wall design is comprised of an inner wall 22 positioned within an outer housing. An intermediate space 32 is preferably between at least a portion of the inner wall 22 and the outer housing to receive any water vapor that passes through the outer housing thereby preventing the entry of the water vapor into the interior space 23 of the inner wall 22.

### B. Multi-Walled Housing.

FIG. 1 illustrates the exterior of the housing showing the outer wall 30. The housing of the present invention includes two or more walls 22, 30 defining at least one space between thereof to prevent the entry of water vapor (and other vapors) into contact with the interior space 23 that contains the switch unit 28 thereby preventing corrosion of the switch unit 28 and related components. The plurality of walls are preferably comprised of an inner wall 22 surrounding the switch unit 28 and an outer wall 30 surrounding the inner wall 22.

While two walls 22, 30 are shown for the present invention in the drawings, more than two walls may be used in the present invention to create multiple intermediate spaces 32 in between each of the walls. For example, three walls could be used wherein there is a first wall, a second wall within the first wall defining a first space between thereof and a third wall within the second wall defining a second space between thereof

The housing is sealed to prevent the entry of liquids and water vapor into the interior of the housing. The housing is further preferably buoyant in a liquid to allow the invention to be used as a float switch 20 in a liquid such as water (e.g. boiler blowdown).

The walls 22, 30 are constructed of a non-metal material capable of withstanding high temperatures. In particular, the walls 22, 30 are constructed of a non-metal material preferably capable of withstanding liquid temperatures up to 212 degrees Fahrenheit or greater.

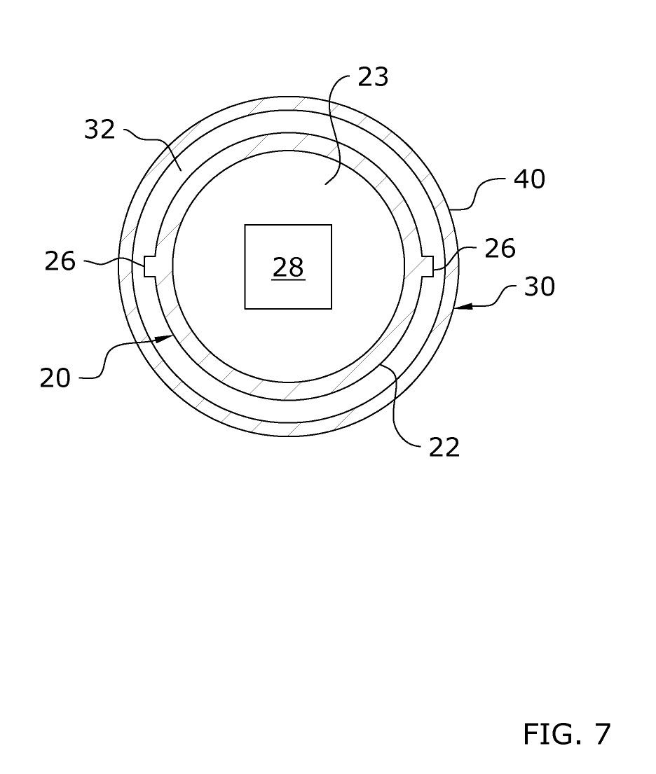

The walls 22, 30 for the housing preferably have a circular cross sectional shape as best illustrated in FIG. 7 of the drawings. However, the walls 22, 30 may have various other cross sectional shapes (e.g. square, rectangular, oval). The walls 22, 30 are preferably constructed of a plastic material such as but not limited to thermoplastic, thermoplastic polymer, polypropylene, polycarbonate, acrylonitrile butadiene styrene (ABS), polycarbonate-ABS alloy. The walls 22, 30 may be formed via various plastic forming procedures such as but not limited to injection molding and rotational molding.

### C. Inner Wall.

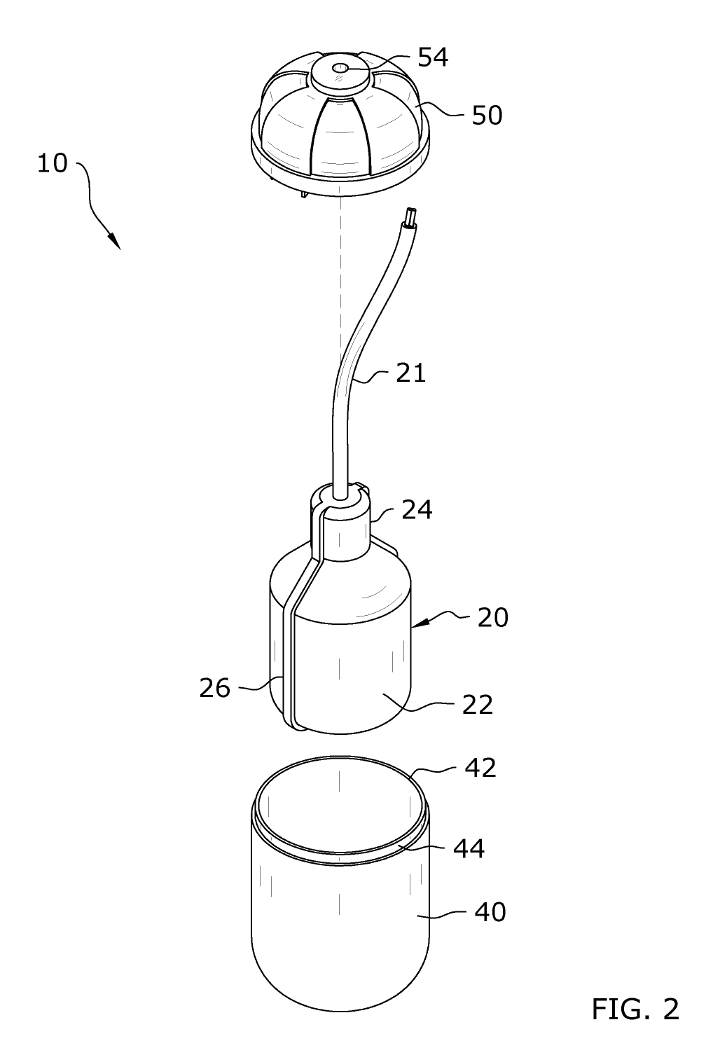

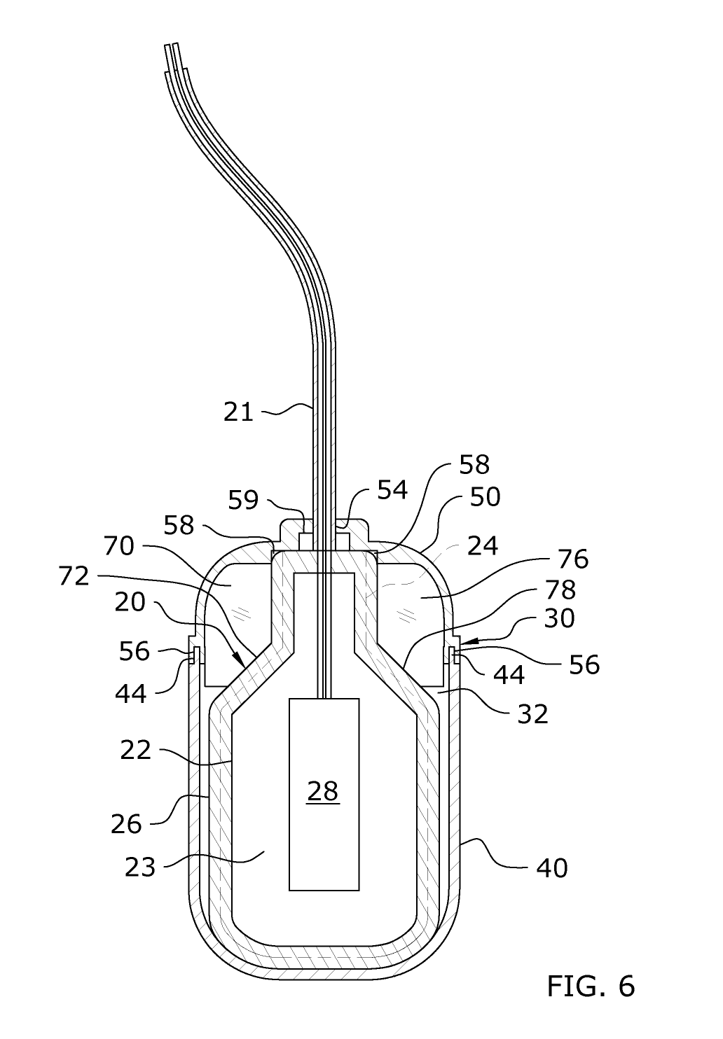

FIGS. 2 and 6 best illustrate the inner wall 22 which is sealed around the switch unit 28 defining an interior space 23. The interior space 23 and the switch unit 28 are sealed by the inner wall 22 to prevent the entry of liquid and water vapor. The inner wall 22 and the switch unit 28 within the inner wall 22 combined may be comprised of a conventional float switch 20 with a cable 21 extending therefrom, wherein the outer wall 30 surrounds the conventional float switch 20. The inner wall 22 includes a rib member 26 that extends outwardly from the inner wall 22 which provides spacing from the interior surface of the outer wall 30. As indicated previously, the inner wall 22 is preferably constructed of a plastic material to help keep manufacturing costs lower compared to using metal walls.

The inner wall 22 may be comprised of a single unitary structure or multiple sections attached together in a sealed manner. While the inner wall 22 may not be sealed, it is preferable to have the inner wall 22 sealed to provide additional protection from water and other liquids that enter through the outer wall 30.

### D. Outer Wall.

The outer wall 30 is formed and adapted to receive the inner wall 22 in a sealed manner to protect the inner wall 22 and the interior space 23 of the inner wall 22. The outer wall 30 may have a shape similar to the shape of the inner wall 22, however, the outer wall 30 may have a different shape than the inner wall 22 as long as the interior cavity formed by the outer wall 30 is large enough to receive the inner wall 22. The outer wall 30 is sealed around the inner wall 22 during the manufacturing process or by the end user during assembly. The outer wall 30 may be manufactured and sold separately from the inner wall 22 to be used with a conventional float switch 20 wherein the end user installs the conventional float switch 20 within the interior cavity of the outer wall 30.

The outer wall 30 may be comprised of a single unitary structure or multiple sections attached together in a sealed manner. While the outer wall 30 may not be sealed, it is preferable to have the outer wall 30 sealed to reduce the amount of liquids and vapor that enter through the outer wall 30.

The outer wall 30 is preferably comprised of a first portion 40 connected to a second portion 50 as best illustrated in FIG. 2 of the drawings. The manufacturer or end user is able to position the inner wall 22 within the second portion 50 with the cable 21 extending outwardly through an aperture 54 within the second portion 50 in a sealed manner and then attaching the first portion 40 to the second portion 50.

The outer wall 30 and the inner wall 22 are preferably comprised of a circular cross sectional area as illustrated in FIG. 7 of the drawings. The outer wall 30 further is preferably comprised of two or more portions 40, 50 that are attached to one another around the inner wall 22 in a sealed manner. FIG. 2 illustrates the outer wall 30 having a first portion 40 with a first open end 42 and a second portion 50 with a second open end 52. The first portion 40 is combined with the second portion 50 with the respective open ends 42, 44 connected together around the inner wall 22 to form the interior cavity of the outer wall 30. The combining of the first portion 40 to the second portion 50 may be done by the manufacturer or the end user with a conventional float switch 20. It is preferable that the outer perimeter of the second portion 50 surrounding the second open end 52 includes a slot 56 that extends along the entire perimeter in a circle pattern, wherein the slot 56 is formed to receive an extended portion 44 that extends outwardly from the first open end 42 of the first portion 40. The extended portion 44 of the first portion 40 may be attached within the slot 56 of the second portion 50 via an adhesive, sealant or other securing material. In addition, the extended portion 44 of the first portion 40 may be attached within the slot 56 of the second portion 50 using a spin welding process.

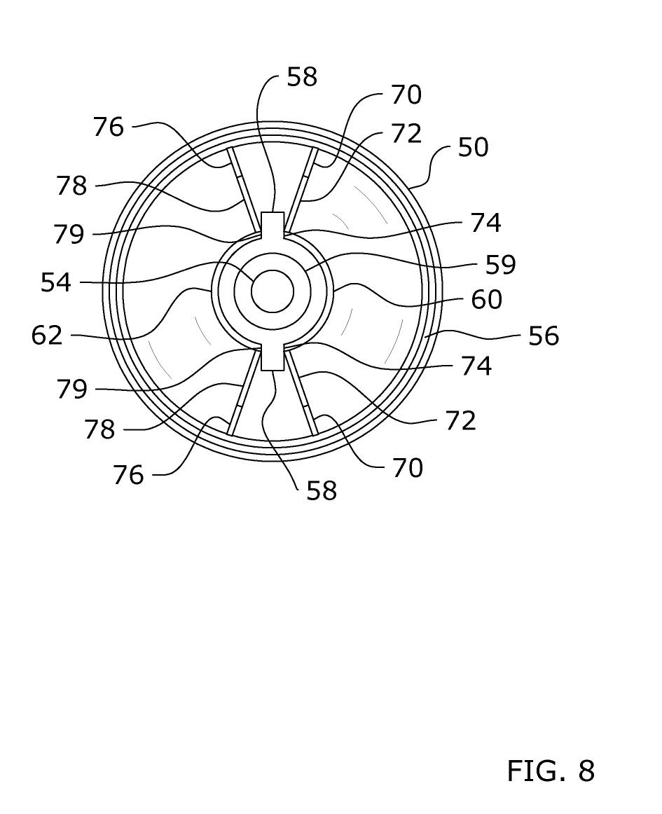

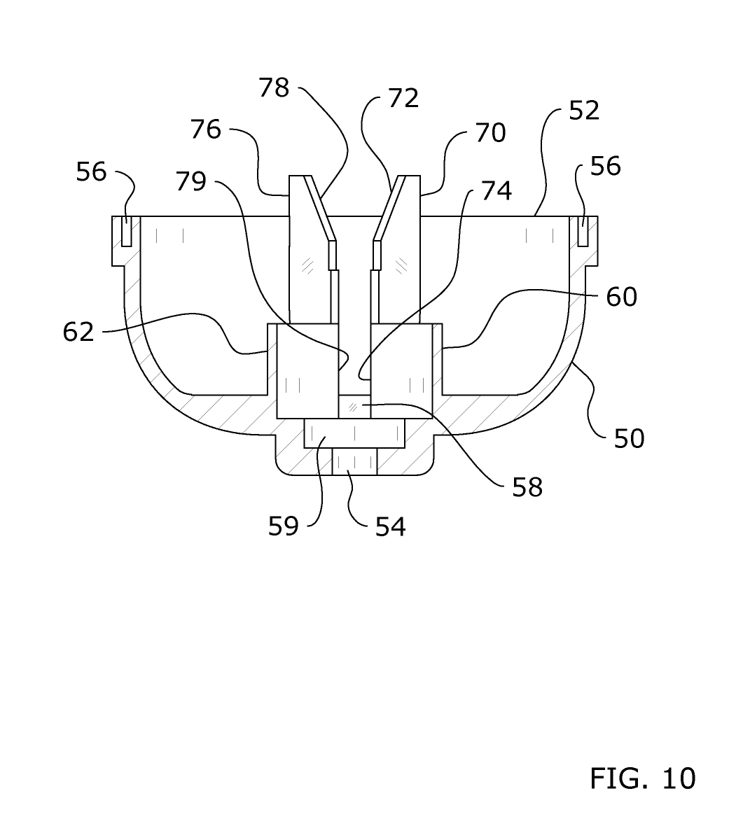

The second portion 50 of the outer wall 30 includes a support structure adapted to support an inner end of the inner wall 22 in a substantially non-movable manner. The support structure is best illustrated in FIGS. 8 through 11 of the drawings. The support structure is adapted and shaped to receive the neck portion 24 of the float switch 20. The support structure prevents side-to-side movement of the inner wall 22 and also prevents rotation of the inner wall 22 within the outer wall 30. The support structure is preferably comprised of a pair of first support members 70 and a pair of second support members 76 that define a first inner edge 74 and a second inner edge 79 respective that are positioned on opposite sides of the rib member 26 that extends along the neck portion 24. In addition, the support members 70, 76 further preferably include a first curved member 60 and a second curved member 62 extending between the respective support members 70, 76 as best illustrated in FIG. 8 of the drawings. The curved members 60, 62 are formed to snugly receive the neck portion 24 of the inner wall 22. To provide additional support for the neck portion 24 of the inner wall 22 surrounding the float switch 20, the second portion 50 further preferably includes a pair of side recessed portions 58 that receive the rib member 26 extending from an inner portion of the neck portion 24 as illustrated in FIGS. 7 and 10 of the drawings. In addition, the support members 70, 76 preferably include a first support edge 72 and a second support edge 78 respective that are each angled outwardly and upwardly to engage an angled/tapered portion of the inner wall 22 of the float switch 20 that extends between the neck portion 24 and the main body of the inner wall 22. The second portion 50 further preferably includes a central recessed portion 59 that receives the epoxy or other sealant surrounding the cable 21 extending from the inner wall 22 as shown in FIGS. 8, 10 and 11 of the drawings.

The first portion 40 includes an aperture 54 to receive a cable 21 extending from the inner wall 22 as illustrated in FIGS. 2 and 6 of the drawings. A sealant is preferably applied to the interior of the outer housing around the cable 21 and within the aperture 54 to provide additional sealing of the interface between the cable 21 and the second portion 50 of the outer wall 30. The aperture 54 is further preferably sized to snugly receive the cable 21 thereby having an interior diameter approximately the same or less than the exterior diameter of the cable 21.

### E. Intermediate Space.

An intermediate space 32 is preferably formed between at least a portion of the inner wall 22 and the outer wall 30. The intermediate space 32 is filled with a gas (e.g. air) and is adapted to receive any water vapor that enters through the outer wall 30 to provide an area for the water vapor to condense thereby preventing entry of the same into the inner wall 22. The intermediate space 32 may be filled with a gas different than air. While the outer wall 30 may be positioned adjacent to the inner wall 22 completely without any intermediate space 32, it is preferable that an intermediate space 32 be provided between the inner wall 22 and the outer wall 30 as illustrated in FIGS. 6 and 7 of the drawings.

It is further preferable that the intermediate space 32 preferably surrounds at least seventy percent of an outer surface of the inner wall 22 thereby providing increased protection of the interior cavity of the inner wall 22. The intermediate space 32 may have various volumes, however, it is preferable that the spacing between the outer surface of the inner wall 22 and the inner surface of the outer wall 30 be at least ¹/4 of an inch to provide sufficient spacing from any vapor that enters through the outer wall 30. The intermediate space 32 is preferably a substantially continuous space surrounding the inner wall 22 as illustrated in the drawings, however, the intermediate space 32 may be comprised of a plurality of completely separate and sealed (or semi-separate and non-sealed) compartments between the inner wall 22 and the outer wall 30.

### F. Switch Unit.

The switch unit 28 is positioned within the interior space 23 of the housing to be protected from the liquid outside of the outer wall 30 and the water vapor that enters through the outer wall 30. The switch unit 28 may be comprised of various types of electrical switches such as but not limited to a mechanical two-stage switch having an open state and a closed state. Various other types of switches may be used for the switch unit 28 such as mercury switches and the like. The cable 21 extends through the inner wall 22 in a sealed manner and is electrically connected to the switch unit 28.

### G. Operation of Preferred Embodiment.

To assemble the present invention, the user positions the float switch 20 having the inner wall 22 (preferably a conventional float switch 20) within the outer wall 30 and then seals the outer wall 30 around the inner wall 22 to create the intermediate space 32. During assembly, the cable 21 from the inner wall 22 is extended through the aperture 54 within the second portion 50 of the outer wall 30. An epoxy or other sealant material is preferably applied to the cable 21 and the interior surface of the outer wall 30 to ensure a proper seal between the cable 21 and the outer wall 30.

The inner end of the inner wall 22 comprised of the neck portion 24 is seated within the support structure within the second portion 50 of the outer wall 30 and then the first portion 40 is positioned over the extended portion 44 of the inner wall 22 to engage the second portion 50 in a sealed manner. The distal end of the inner wall 22 (e.g. the rib member 26 extending from the distal end of the inner wall 22) preferably is engaged by the inner surface of the distal end of the first portion 40 to retain the inner wall 22 within the support structure within the second portion 50 as illustrated in FIG. 6 of the drawings.

The first portion 40 and the second portion 50 of the outer wall 30 are attached and sealed together forming an interior cavity that receives the inner wall 22. The outer wall 30 further forms an intermediate space 32 between the outer wall 30 and the inner wall 22 when fully assembled as illustrated in FIGS. 6 and 7 of the drawings.

In use, the user electrically connects the cable 21 to a control panel or other electronic device that is capable of using the data received by the float switch 20. The present invention is supported by the cable 21 within the tank to determine the liquid level within the tank. When the liquid level within the tank rises the float switch 20 either closes or opens depending upon the desired state when the tank rises to a specified level within the tank. If the liquid is at a high temperature (e.g. higher than 100 degrees Fahrenheit), the water vapor or other high temperature vapor within the tank may permeate through the outer wall 30 and into the intermediate space 32. When the water vapor enters the intermediate space 32, the water vapor is condensed thereby preventing entry through the inner wall 22 which is impermeable to liquids (the outer wall 30 is also impermeable to liquids). This float switch 20 is allowed to operate as a conventional float switch 20 with the outer wall 30 protecting the electrical components including the switch unit 28 within the float switch 20 from corrosion and other interference by water or water vapor thereby extending the useful life of the float switch 20.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A float switch, comprising:
a housing having a plurality of walls; and
a switch unit positioned within said housing.

2. The float switch of claim 1, wherein said switch unit is comprised of a mechanical switch or a mercury switch.

3. The float switch of claim 2, wherein said mechanical switch is comprised of a two-stage switch having an open state and a closed state.

4. The float switch of claim 1, wherein said housing is sealed and buoyant in a liquid.

5. The float switch of claim 1, wherein said plurality of walls are comprised of an inner wall surrounding said switch unit and an outer wall surrounding said inner wall.

6. The float switch of claim 5, wherein said outer wall is sealed around said inner wall.

7. The float switch of claim 6, wherein an intermediate space is formed between at least a portion of said inner wall and said outer wall.

8. The float switch of claim 7, wherein said intermediate space surrounds at least seventy percent of an outer surface of said inner wall.

9. The float switch of claim 6, wherein said inner wall is sealed around said switch unit defining an interior space, wherein said interior space is sealed by said inner wall.

10. The float switch of claim 5, wherein said inner wall is sealed around said switch unit defining an interior space, wherein said interior space is sealed by said inner wall.

11. The float switch of claim 5, wherein said inner wall and said outer wall are comprised of a non-metal material.

12. The float switch of claim 11, wherein said inner wall and said outer wall are comprised of a plastic material.

13. The float switch of claim 5, wherein said inner wall includes a rib member that extends outwardly from said inner wall.

14. The float switch of claim 5, wherein said outer wall is comprised of a first portion connected to a second portion, wherein said first portion includes an aperture to receive a cable extending from said inner wall.

15. The float switch of claim 14, wherein said second portion of said outer wall includes a support structure adapted to support an inner end of said inner wall in a substantially non-movable manner.

16. The float switch of claim 5, wherein said inner wall and said switch unit within said inner wall are comprised of a conventional float switch, wherein said outer wall surrounds said conventional float switch.

17. The float switch of claim 1, wherein said plurality of walls of said housing are comprised of a non-metal material.

18. The float switch of claim 17, wherein said plurality of walls of said housing are comprised of a plastic material.

19. A float switch, comprising:
a housing having a plurality of walls, wherein said housing is sealed and buoyant in a liquid;
wherein said plurality of walls are comprised of a non-metal material; and
a switch unit positioned within said housing, wherein said switch unit is comprised of a mechanical switch, wherein said mechanical switch is comprised of a two-stage switch having an open state and a closed state;
wherein said plurality of walls are comprised of an inner wall surrounding said switch unit and an outer wall surrounding said inner wall;
wherein said outer wall is sealed around said inner wall;
wherein said inner wall is sealed around said switch unit defining an interior space, wherein said interior space is sealed by said inner wall;
wherein an intermediate space is formed between at least a portion of said inner wall and said outer wall, wherein said intermediate space is filled with a gas and wherein said intermediate space surrounds at least seventy percent of an outer surface of said inner wall.

20. The float switch of claim 19, wherein said inner wall and said outer wall are comprised of a plastic material.
